(19) United States
(12) Patent Application Publication
(10) Pub. No.: US 2006/0164307 A1
(43) Pub. Date: Jul. 27, 2006

(54) Low profile antenna

(75) Inventors: James Lesley Smith, Garland, TX (US); James W. McCoy, Plano, TX (US)

Correspondence Address: HAYNES AND BOONE, LLP, 901 MAIN STREET, SUITE 3100, DALLAS, TX, 75202, US

(73) Assignee: InnerWireless, Inc., Richardson, TX (US)

(21) Appl. No.: 11/295,765

(22) Filed: Dec. 7, 2005

Related U.S. Application Data
(60) Provisional application No. 60/647,273, filed on Jan. 26, 2005.

(51) Int. Cl. H01Q 1/38

(52) U.S. Cl. 343/700 MS

(57) ABSTRACT

Provided is an antenna. In one example, the antenna includes a base having a substantially planar upper surface with an axis perpendicular to the upper surface. The base forms a ground plane for the antenna. The antenna also includes at least three conductive planar elements that are substantially triangular and are electrically coupled to the base via a feed point. Each element has a vertical edge oriented parallel to the base's axis and a horizontal edge oriented parallel to the upper surface. An angle formed by the intersection of the vertical and horizontal edges of each element is located on the base's axis and is distal from the feed point. The elements are positioned equidistantly from the base and equiangularly from one another. The vertical edges of the elements are coupled along the base's axis to form a contiguous conductive surface that is a driven element of the antenna.

### CROSS-REFERENCE

This application claims priority from U.S. Provisional Patent Ser. No. 60/647,273, filed on Jan. 26, 2005, and hereby incorporated by reference.

### BACKGROUND

The rapid adoption of multiple wireless services operating at widely dispersed frequencies presents a challenge for conventional antenna designs, which typically focus on relatively narrowband characteristics in single, dual, or triple band configurations. Such designs are increasingly difficult to implement as existing frequency bands are expanded and new bands are made available to deliver new services.

### BRIEF DESCRIPTION OF THE DRAWINGS

FIG. 1 is a perspective view of one embodiment of an antenna having three antenna elements coupled to a base.

FIG. 2 is side view of one embodiment of an antenna element that may be used in the antenna of FIG. 1.

FIG. 3 is a perspective view of an embodiment of an antenna having two interlocking blades coupled to a base.

FIGS. 4a and 4b are side views of one embodiment of the two interlocking blades that may be used in the antenna of FIG. 3.

FIG. 5 is a perspective view of one embodiment of a base that may be used in the antenna of FIG. 3.

FIG. 6a is a perspective view of an embodiment of the antenna of FIG. 3 with a planar cover.

FIG. 6b is a top view of one embodiment of a cover that may be used in the antenna of FIG. 6a.

FIG. 7 is a perspective view illustrating an exemplary cover element attached to the base of the antenna of FIG. 3 or FIG. 6a.

FIG. 8 is another embodiment of an antenna having four triangular elements.

FIG. 9 illustrates the antenna of FIG. 8 with a planer cover.

FIG. 10 illustrates the antenna of FIG. 8 with one embodiment of a conductive ring.

FIG. 11 illustrates the antenna of FIG. 8 with another embodiment of a conductive ring.

FIG. 12 illustrates an exemplary environment within which one of the antennas of FIGS. 1, 3, 6a, or 8-11 may be used.

### DETAILED DESCRIPTION

The present disclosure is directed to an antenna for transmitting and receiving electromagnetic signals and, more specifically, to a low profile multi-octave omni-directional surface mountable antenna. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

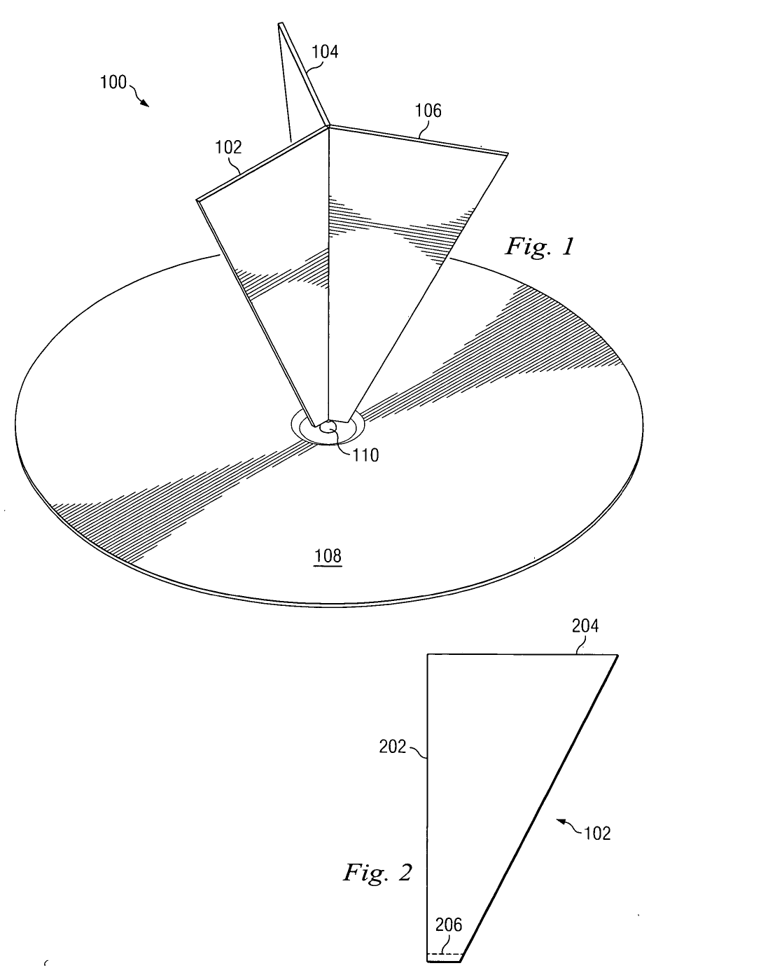

Referring to FIG. 1, in one embodiment, an antenna 100 illustrates an antenna configuration using a broadband multi-octave radiation structure that balances antenna efficiency, bandwidth, polarization, gain, and directivity. The antenna 100 includes three substantially triangular antenna elements 102, 104, and 106 connected to a base 108 (e.g., a disc) that is a contiguous conductive surface. As will be described below in greater detail, the base 108 is the ground plane and the antenna elements 102, 104, and 106 provide a driven element that is a representation of a cone. The positioning of the base 108 as the ground plane and the antenna elements 102, 104, and 106 as the driven element enables the feed point 110 to be inverted compared to a conventional discone antenna. This inversion makes the antenna 100 suitable for installation above an intended coverage area (e.g., surface mounted to ceiling) with the base 108 positioned above the antenna elements 102, 104, and 106. It is understood, however, that other mounting orientations may be used.

The antenna elements 102, 104, and 106 are electrically coupled to the base 108 via the feed point 110. The antenna elements 102, 104, and 106 are electrically also coupled to each other along their vertical edges to form a conductive surface. The antenna elements 102, 104, 106 are arranged for equiangular spacing around the feed point 110, and are each offset from the base 108 by a predetermined distance spanned by the material forming the feed point.

With additional reference to FIG. 2, the antenna element 102 is illustrated in greater detail and includes a vertical edge 202 and a horizontal edge 204. The total length of the vertical edge 202 may be less than one quarter wavelength above the base 108 at the lowest frequency of operation of the antenna 100. In the present example, the antenna element 102 is constructed of a metal or metal alloy, but it is understood that the antenna element may be formed using any suitable conductive material. Although not illustrated in detail, the antenna elements 104 and 106 are similar or identical in size and construction.

In the present disclosure, the apex of a mathematical cone represented by the antenna elements 102, 104, and 106 represents a truncated cross section of the cone, but optimizes the height above the disc 108 at which the truncation occurs. This aids, for example, in extending the high frequency response of the antenna 100. Furthermore, impedance matching stubs (not shown) may be positioned on one or more of the antenna elements 102, 104, 106 at or near the point of truncation (illustrated by line 206 in FIG. 2) to better match the feed-point impedance to the radiating impedance. This may further extend the high frequency operation of the antenna 100, which improves the efficiency of the antenna over its entire operational frequency range.

Unlike conventional discone antennas, the use of the antenna elements 102, 104, and 106 extends the effective length of the conductor (e.g., adds perimeter length which is equivalent to adding length to the rods in conventional approximations) and partially closes the base of the mathematical cone. In the present embodiment, this effect may be used to reduce the total height of the cone above the disc 108. For example, if the included half-angle of the cone is thirty degrees, the height of the cone may be reduced by thirty-three percent while achieving equivalent performance at the lowest frequency of operation. An additional benefit of reducing the total height of the cone may be that the inherent variation in elevation angle (theta) of peak directivity as a function of frequency (minimum to maximum) is correspondingly reduced.

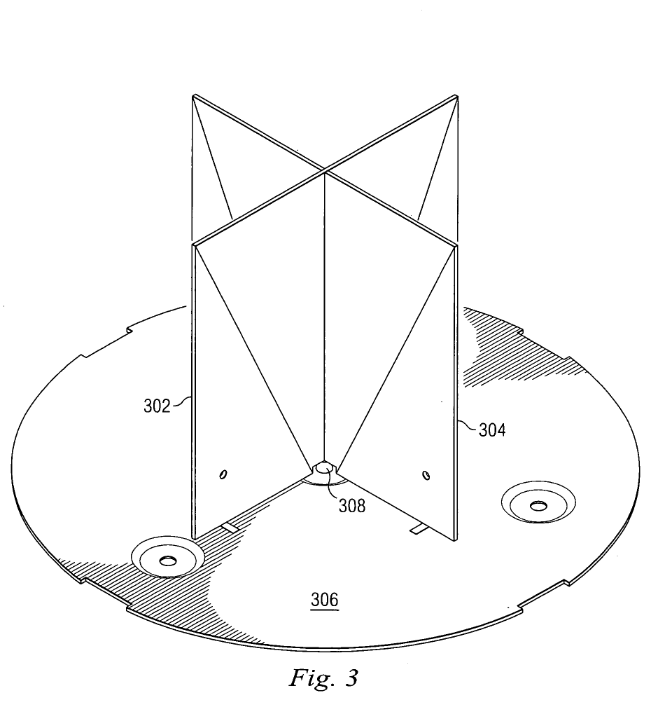

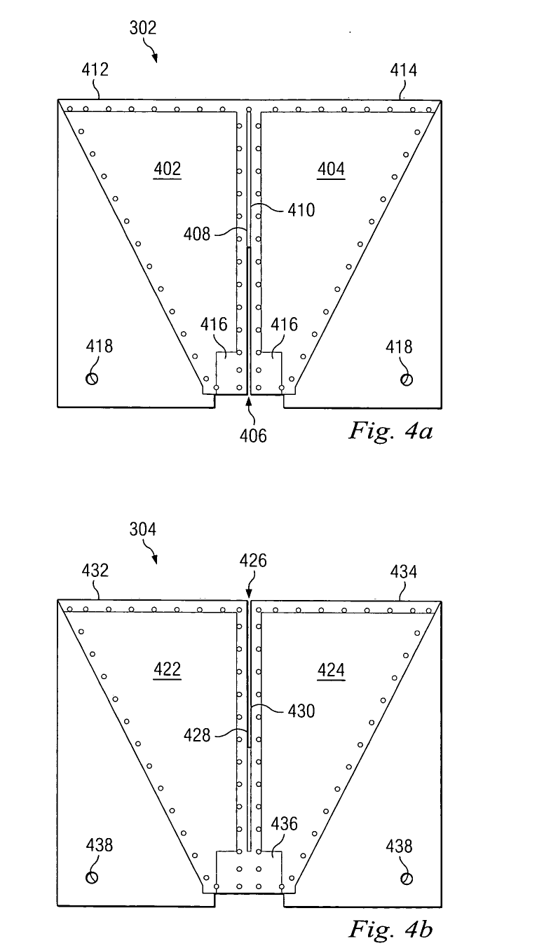

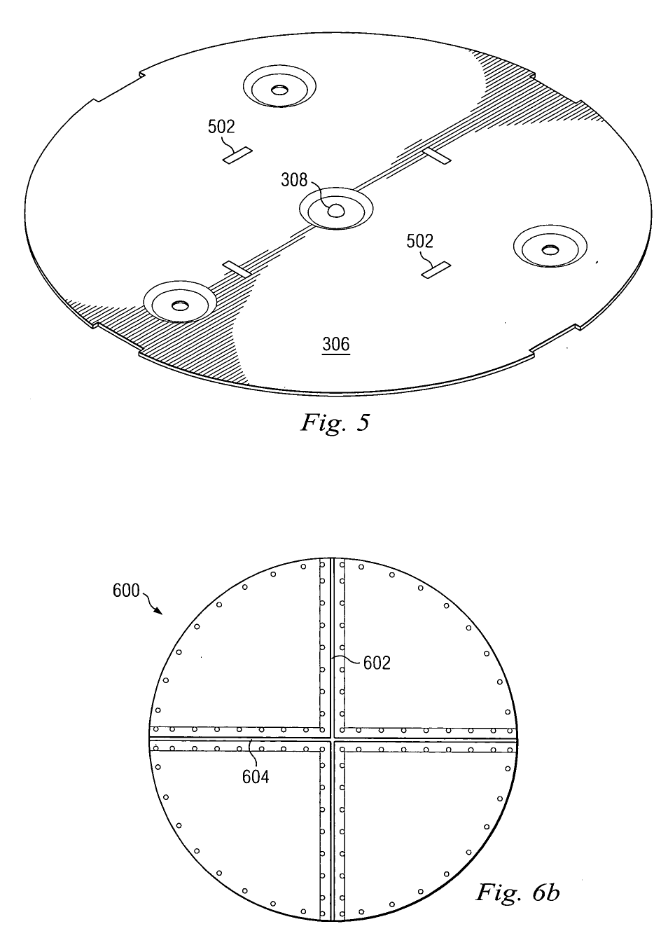

Referring to FIG. 3 and with additional reference to FIGS. 4a, 4b, and 5, in another embodiment, an antenna 300 includes two interlocking blades 302 and 304 coupled to a base 306. As will be described in greater detail with respect to FIG. 4, conductive elements on the interlocking blades 302 and 304 form a representation of a cone, with the base 306 as a ground plane and the conductive elements as the driven element. As with the antenna 100 of FIG. 1, this enables a feed point 308 connecting the conductive elements to the base 306 to be inverted compared to a conventional discone antenna, which makes the antenna 300 suitable for installation above an intended coverage area.

The use of blades 302 and 304 allows for ease in manufacture and also aids in the approximation of an omni-directional radiation characteristic. In addition, the use of blades 302 and 304 imparts structural integrity to the antenna 300 that provides flexibility in choosing design characteristics. For example, the tendency of conventional antennas to use the cone portion of a discone antenna as the ground is at least partly due to the practical need to maintain sufficient structural integrity. By truncating the apex of the cone, it is possible to use a sufficiently rigid feed point (center conductor) to sustain the mechanical loads of the disc. The use of printed circuit boards (discussed below with respect to FIG. 4) as the blades 302, 304 enables a dielectric portion of each blade to directly contact the base 306. This allows each blade to be mechanically secured to the base 306 independently from the connection of the feed point 308. By freeing the feed point 308 from the mechanical constraint of supporting the blades 302 and 304, the present embodiment is able to extend the high frequency operation of the antenna 300 to multi-octave capability.

As illustrated in greater detail in FIG. 4a, the blade 302 is formed on a dielectric printed circuit board. Two antenna elements 402 and 404, which are substantially triangular in the present example, are formed on the circuit board 302 using techniques known to those of skill in the art (e.g., screening, etching, and plating processes). Although the blade 302 is described in terms of separate antenna elements 402 and 404 for purposes of clarity, it is understood that the two antenna elements may be formed as a single element. Additionally, although not shown, it is understood that the opposite surface of the blade 302 is similar or identical to that shown in FIG. 4a. A slot 406 is formed in the circuit board 302 to allow the circuit board to engage an opposing slot in the blade 304 (FIG. 4b).

Each antenna element 402 and 404 includes a vertical edge 408, 410, respectively, and a horizontal edge 412, 414, respectively. The lower corner of each of the antenna elements 402 and 404 (e.g., the corner nearest the feed point 308) is truncated and is offset from the lower edge of the circuit board 302 (by about 0.125 inches in the present example). The blade 302 may also include one or more impedance matching stubs 416 at or near the point of truncation to better match the impedance of the feed point to the radiating impedance, which may serve to extend the high frequency operation of the antenna 300. For purposes of example, the total width of the combined antenna elements 402, 404 is 4.0 inches and each element is 3.125 inches tall. The slot 406 is 0.04 inches wide and 1.675 inches high. The circuit board 302 includes one or more coupling means 418 (e.g., holes, protrusions, or brackets) by which the circuit board may be fastened to the base 306 (FIG. 3).

As illustrated in greater detail in FIG. 4b, the blade 304 is substantially similar or identical to the blade 302 (FIG. 4a) and includes antenna elements 422 and 424. Although the blade 304 is described in terms of separate antenna elements 422 and 424 for purposes of clarity, it is understood that the two antenna elements may be formed as a single element. Additionally, although not shown, it is understood that the opposite surface of the blade 304 is similar or identical to that shown in FIG. 4b. A slot 426 is formed in the circuit board 302 to allow the circuit board to engage the slot in the blade 302 (FIG. 4a).

Each antenna element 422 and 424 includes a vertical edge 428, 430, respectively, and a horizontal edge 432, 434, respectively. As in the blade 302, the lower corner of each of the antenna elements 402 and 404 (e.g., the corner nearest the feed point 308) is truncated and is offset from the lower edge of the circuit board 304 (by about 0.125 inches in the present example). The blade 304 may also include one or more impedance matching stubs 436 at or near the point of truncation. For purposes of example, the total width of the combined antenna elements 422, 424 is 4.0 inches and each element is 3.125 inches tall. The slot 426 is 0.04 inches wide and 1.675 inches high. The circuit board 304 includes one or more coupling means 438 (e.g., holes, protrusions, or brackets) by which the circuit board may be fastened to the base 306 (FIG. 3).

As illustrated in FIG. 5, the base 306 in the present example is a metal disc. The disc 306 provides structural integrity to the antenna 300 and operates as a ground plane. While substantially planar, the disc 306 may include mounting means 502 (e.g., holes, protrusions, or brackets) positioned to correspond to the coupling means 418 and 438 of the blades 302 and 304, as well as mounting means (not shown) for attaching the antenna to a surface. In addition, the feed point 308 may be elevated or otherwise physically differentiated from the remainder of the disc 306.

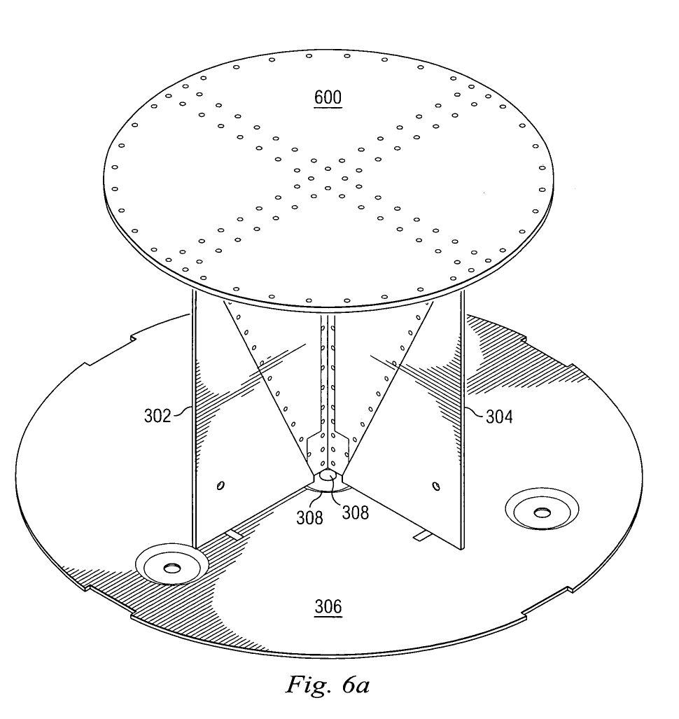

Referring to FIG. 6a, in yet another embodiment, a planar cover 600 may be coupled to the upper edges of the blades 302 and 306 of FIG. 3. The cover 600, which is electrically connected to the antenna elements of the blades 302, 304 and is parallel to the disc 306 (e.g., the ground plane), may aid in configuring the antenna 300 for broadband multi-octave operation. More specifically, the cover 600 may be used to alter the radiation impedance and have the effect of increasing the effective length of the conductor (and allowing a downward extension of operating frequency range). For example, the addition of the cover 600 results in a closed base for the mathematical cone represented by the antenna elements of the blades 302 and 304, which allows a greater than fifty percent reduction in cone height above the disc 306 when compared to conventional practice. An additional benefit of reducing the total height of the mathematical cone is that when used as a multi-octave antenna, the inherent variation in elevation angle (theta) of peak directivity as a function of frequency (minimum to maximum) is correspondingly reduced.

With additional reference to FIG. 6b, in the present example, the cover 600 is a, disc formed using a printed circuit board. The cover 600 includes two grooves 602, 604 that are plated or lined with a conductive material. Each of the grooves 602, 604 have a width corresponding to a thickness of the blades 302, 304. The upper edge of each blade 302, 304 (e.g., the horizontal edges 412, 414, 432, and 344 of FIGS. 4a and 4b) fits into one of the grooves 602, 604. For purposes of example, the cover 308 is four inches in diameter (which is identical to the total width of the combined antenna elements 402, 404 and 432, 434 as illustrated in FIGS. 4a and 4b).

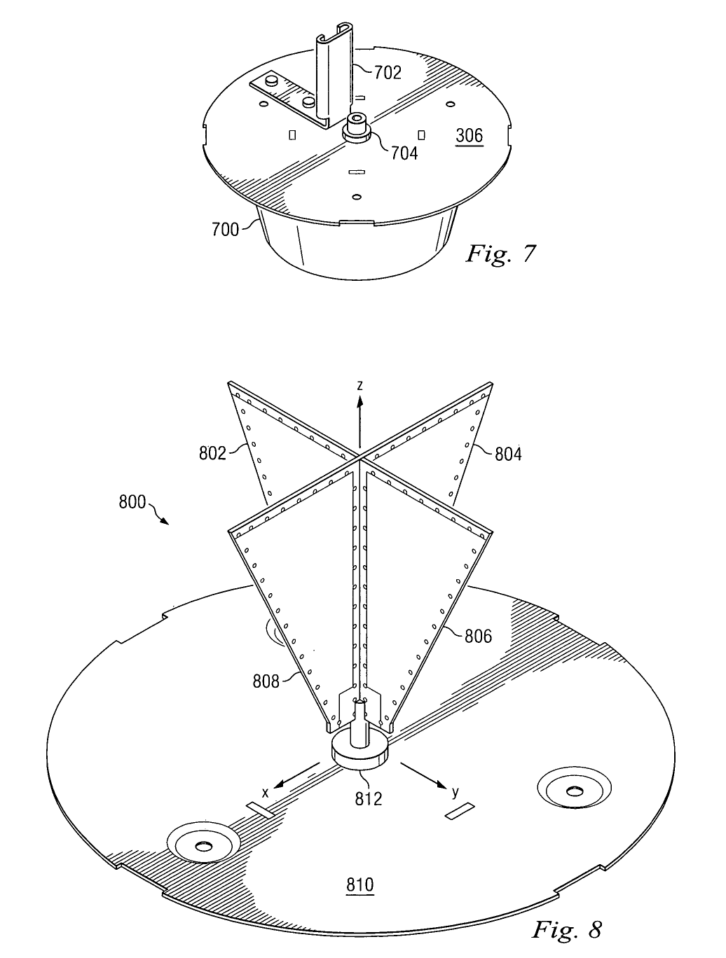

Referring to FIG. 7, in still another embodiment, the antenna 300 of FIG. 3 is illustrated with a covering element 700. The covering element 700 is attached to the disc 306 over the blades 302 and 304. Additionally, a fastener 702 is coupled to the disc 306 for fastening the antenna 300 to a structure. For example, the antenna 300 may be surface mounted to a ceiling (see FIG. 12). A transmission line (not shown) may attach to a connector 704 for receiving and/or transmitting signals via the antenna 300.

Referring to FIG. 8, in another embodiment, an antenna 800 includes four conductive elements 802, 804, 806, and 808. Each of the elements 802, 804, 806, and 808 are coupled to form a contiguous conductive surface as previously described. The elements 802, 804, 806, and 808 form a driven element of the antenna 800 and are electrically coupled to a base 810 that forms a ground plane for the antenna 800. The elements 802, 804, 806, and 808 are elevated from and electrically coupled to the base 810 via a feed point 812.

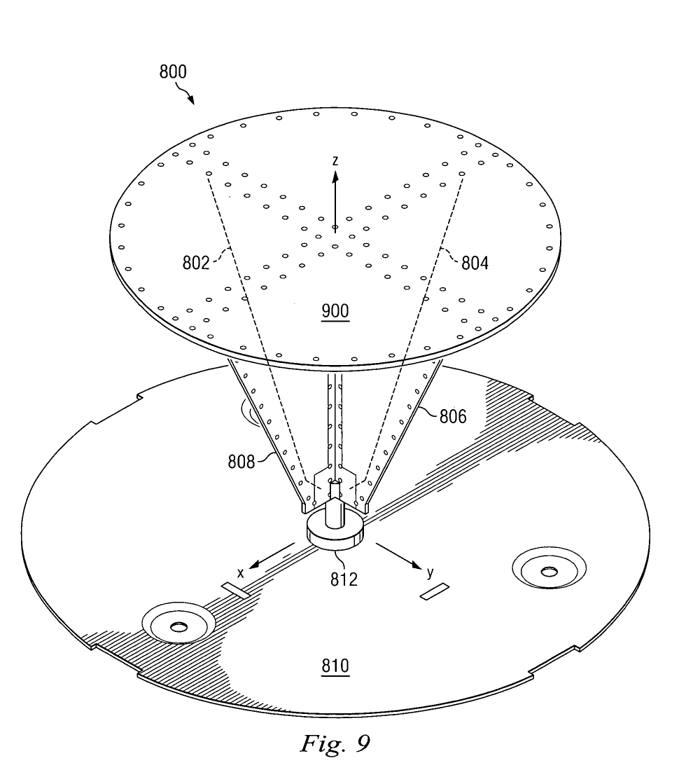

Referring to FIG. 9, in yet another embodiment, the antenna 800 of FIG. 8 is illustrated with a cover element 900 that is at least partially conductive. As described previously, the cover element 900 alters the radiation impedance and effectively increases the length of the conductor and extends the operating frequency range of the antenna 800.

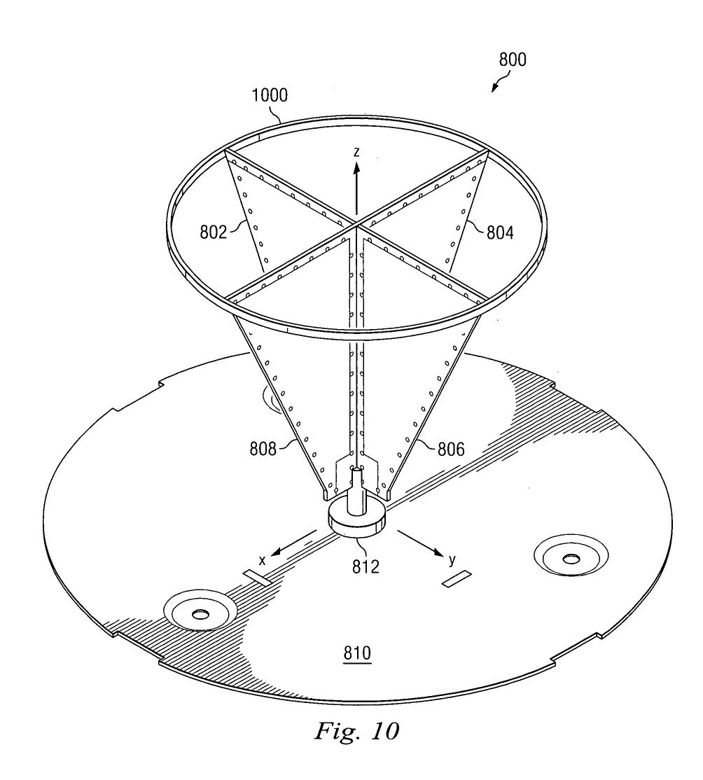

Referring to FIG. 10, in still another embodiment, the antenna 800 of FIG. 8 is illustrated with a conductive ring 1000. The ring 1000 is electrically coupled to each of the elements 802, 804, 806, and 808. In the present example, the ring 1000 is connected to the outer vertical edge of each of the elements 802, 804, 806, and 808 to optimize the radiation impedance and to adjust the elevation angle peak directivity at specific frequencies. The ring 1000 may be positioned at selected heights above the base 810 to select the frequency at which the optimization occurs. It is understood that, although a single ring 1000 is illustrated, multiple rings may be used (e.g., at varying heights relative to the base 810) for selecting multiple frequencies.

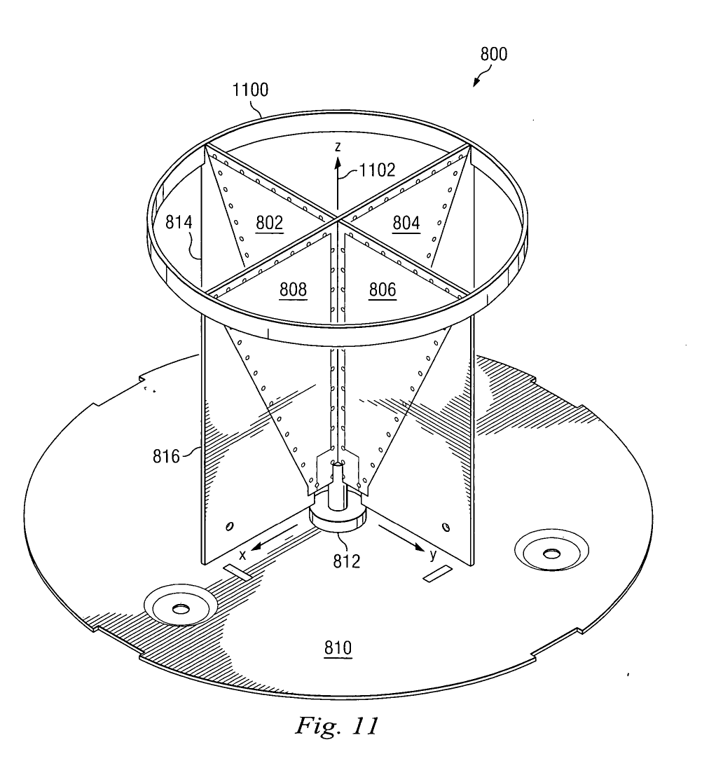

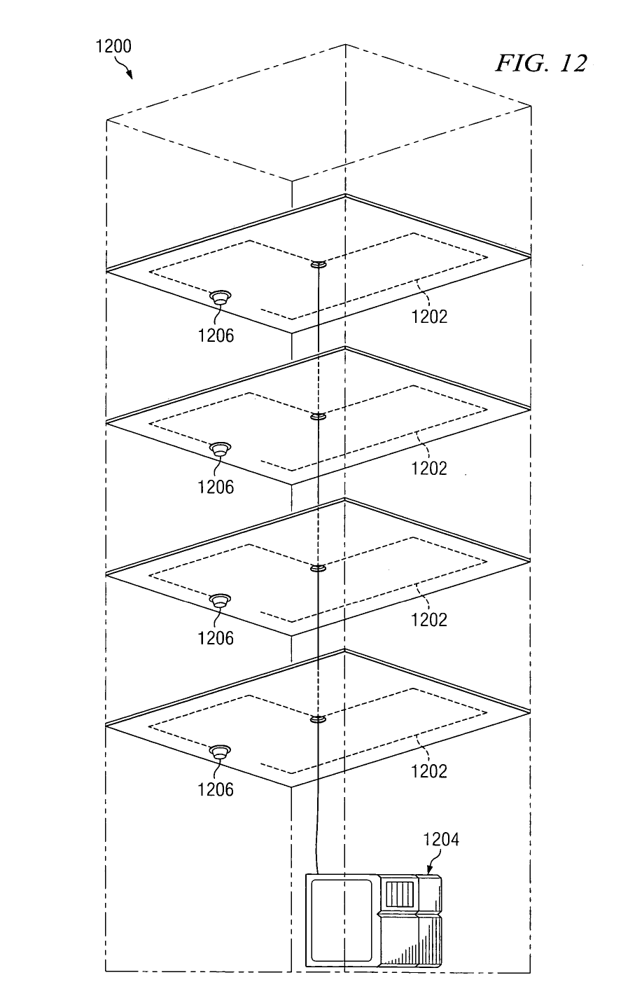

Referring to FIG. 11, in yet another embodiment, the antenna 800 of FIG. 8 is illustrated with a conductive ring 1100. In the present example, the ring 1100 represents a partial cylindrical shell that is centered on an axis 1102 that is perpendicular to the surface of the disc 810 and is parallel to the vertical edge of each of the elements 802, 804, 806, and 808. The ring 1100 is electrically coupled to each of the elements 802, 804, 806, and 808. The ring 1100 is connected to the outer vertical edge of each of the elements 802, 804, 806, and 808 to optimize the radiation impedance and to adjust the elevation angle peak directivity at specific frequencies. The ring 1000 (or rings, if desired) may be positioned at selected heights above the base 810 to select the frequency (or frequencies) at which the optimization occurs. In the present example, each of the elements 802, 804, 806, and 808 is formed on one of two printed circuit boards 814, 816, as is described in greater detail with respect to FIGS. 3 and 4. Each of the circuit boards 814 and 816 include a notch that supports the ring 1100.

Referring to FIG. 12, one embodiment of an environment 1200 is illustrated within which one or more antennas 1206 (e.g., one of the antennas described in the preceding embodiments) may be used. The environment 1200 includes a multi-story building having a plurality of antennas (e.g., the antenna 300 of FIG. 3) connected to radiating coaxial cables 1202. The cables 1202 extend into a telecom room 1204 that provides connection to various external systems and networks (not shown), such as the internet. It is understood that the environment 1200 is merely one example of an environment that may utilize the antennas described in the present disclosure, and that many other environments are envisioned.

The antennas described in the preceding embodiments may be used to ensure signal quality inside man-made structures such as buildings (e.g., the environment 1200). The complex signal propagation environment inside buildings dictates use of an antenna with well behaved polarization, true omni-directional patterns, and high efficiency. The aesthetics of, and limited available space for, in-building installation dictate a physical size less than a normally required quarter wavelength monopole above a ground plane (at the lowest frequency of operation). For example, a thin linear monopole operating at 450 MHz would generally require an 8.35 inch diameter ground plane and a 6.56 inch wire monopole. The multiplicity of frequencies to be transmitted and received strongly favors a physical structure inherently capable of contiguous frequency operation across multi-octaves. Accordingly, the antennas described herein may be used within the environment 1200 and similar environments.

While the preceding description shows and describes one or more embodiments, it will be understood by those skilled in the art that various changes in form and detail may be made therein without departing from the spirit and scope of the present disclosure. For example, various portions of an antenna described in one embodiment may be used with an antenna described in another embodiment. Also, the shape of the conductive elements, base, and/or planar cover may vary. Furthermore, supplied measurements are for purposes of example, and antennas having different measurements may be constructed. Also, it is understood that the description of various elements as being separate (and having separate vertical and horizontal edges) is for purposes of convenience, and that elements described separately (e.g., the elements 402 and 404 of FIG. 4a) may equally be described as a single element. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. An antenna comprising:
a base having a substantially planar upper surface with an axis perpendicular to the upper surface, wherein the base is at least partially conductive and forms a ground plane for the antenna; and
at least first, second, and third conductive planar elements that are substantially triangular and are electrically coupled to the base via a feed point, each of the first, second, and third elements having a vertical edge oriented parallel to the base's axis and a horizontal edge oriented parallel to the upper surface, wherein an angle of each element formed by the intersection of the vertical and horizontal edges of each element is located on the base's axis and is distal from the feed point, and wherein the elements are positioned equidistantly from the base and equiangularly from one another, and wherein the vertical edges of the elements are coupled along the base's axis to form a contiguous conductive surface that is a driven element of the antenna.

2. The antenna of claim 1 wherein a corner of each of the first, second, and third elements formed by the intersection of the vertical edge and an angled edge is truncated to form a lower edge substantially parallel with the upper surface, and wherein a material forming the feed point connects to each of the first, second, and third elements at the lower edge.

3. The antenna of claim 2 wherein the lower edge of each of the first, second, and third elements is separated from the base by a gap, and wherein the gap is bridged by the material forming the feed point.

4. The antenna of claim 2 further comprising impedance matching stubs coupled to the first, second, and third elements proximate to the base to improve a match between an impendence of the feed point and a radiating impedance of the antenna.

5. The antenna of claim 1 further including a dielectric portion coupled to each of the first, second, and third elements, wherein the dielectric portion is connected directly to the base.

6. The antenna of claim 1 further comprising a conductive ring, wherein the conductive ring is coupled to each of the first, second, and third elements at a corner formed by the intersection of the horizontal edge and an angled edge of each of the elements, and wherein the conductive ring has a radius that is approximately equal to the length of the horizontal edge of each element.

7. The antenna of claim 6 wherein the conductive ring is a cylindrical shell oriented with the base's axis as the cylindrical shell's axis.

8. The antenna of claim 1 further comprising a cover coupled to the horizontal edge of each of the first, second, and third elements.

9. The antenna of claim 8 wherein the cover is a disc having a radius substantially equal to a length of the horizontal edge of each of the elements, and wherein the disc is oriented with the base's axis perpendicularly intersecting the center of the disc.

10. The antenna of claim 9 wherein the disc includes first, second, and third grooves positioned to engage the horizontal edge of the first, second, and third elements, respectively, and wherein the first, second, and third grooves include a conductive material.

11. The antenna of claim 1 wherein each of the first, second, and third elements is formed on a printed circuit board.

12. The antenna of claim 1 wherein the base and the first, second, and third elements are proportionally sized so as to provide the antenna with a radiation pattern substantially like that of a discone antenna.

13. The antenna of claim 1 wherein the base is formed of a conductive material.

14. The antenna of claim 1 further comprising a cover that attaches to the base and envelops the first, second, and third elements.

15. The antenna of claim 1 further comprising a fastener coupled to a lower surface of the base for attaching the base to a structure, wherein the base is oriented above the first, second, and third elements when so attached.

16. An antenna comprising:
a base having a substantially symmetrical planar upper surface with an axis perpendicular to the upper surface, wherein the base is at least~partially conductive and forms a ground plane for the antenna; and
at least first and second blades that interlock to form a contiguous conductive surface that is a driven element of the antenna, each blade having:
a dielectric portion coupled to the base; and
at least two substantially triangular conductive portions electrically coupled to the base via a feed point, the conductive portions each having a vertical edge oriented along the axis perpendicular to the upper surface and a horizontal edge oriented parallel to the upper surface, wherein a corner formed by the intersection of the vertical and horizontal edges is located on the base's axis and distal from the feed point; and
an interlocking slot positioned at least partially between the two conductive portions and configured to engage the other blade.

17. The antenna of claim 16 further comprising a disc coupled to the horizontal edges of the conductive portions of the first and second blades, wherein the disc has a radius substantially equal to a length of the horizontal edge of each of the conductive portions, and wherein the disc is oriented with the base's axis perpendicularly intersecting the center of the disc.

18. The antenna of claim 17 wherein the disc includes a groove corresponding to the horizontal edge of each conductive portion of the first and second blades, wherein each groove includes a conductive material.

19. The antenna of claim 18 wherein the disc is a printed circuit board and wherein the grooves are plated with a conductive material.

20. The antenna of claim 16 wherein each blade comprises a circuit board formed of a dielectric material, and wherein the first and second conductive portions are formed on each side of the circuit board.

21. The antenna of claim 16 further comprising:
a lower edge on each conductive portion, wherein the lower edge is defined by truncating a corner formed by the intersection of the vertical edge and an angled edge proximate to the base; and
a lower slot formed in an edge of each of the first and second blades proximate to the base, wherein the lower slot is centered on the feed point and separates the lower edge of each conductive portion from the base, and wherein a material forming the feed point couples the lower edge of each conductive portion and the base.

22. The antenna of claim 21 wherein the lower edge of each conductive portion is substantially parallel with the upper surface.

23. The antenna of claim 16 further comprising an impedance matching stub located on each of the first and second blades near the feed point to improve a match between an impendence of the feed point and a radiating impedance of the antenna.

24. The antenna of claim 16 wherein the base and the two substantially triangular conductive portions of the first and second blades are proportionally sized so as to provide the antenna with a radiation pattern substantially like that of a discone antenna.

25. The antenna of claim 16 wherein the base is formed entirely of a conductive material.

26. The antenna of claim 16 further comprising a cover that attaches to the base and substantially envelops the first and second blades.

27. The antenna of claim 16 further comprising a fastener coupled to a lower surface of the base for attaching the base to a structure, wherein the base is oriented above the first and second blades when so attached.
